(19) United States
(12) Patent Application Publication
(10) Pub. No.: US 2005/0153146 A1
(43) Pub. Date: Jul. 14, 2005

(54) Process for coating a substrate

(75) Inventors: Siegfried Thurm, Meerbusch (DE); Michael Mager, Leverkusen (DE); Robert Maleika, Dusseldorf (DE); Uwe Noreiks, Rheinberg (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/000,862

(22) Filed: Dec. 1, 2004

(30) Foreign Application Priority Data
Dec. 5, 2003 (DE) 10356823.9

(51) Int. Cl. B32B 9/04

(52) U.S. Cl. 428/448

(57) ABSTRACT

The invention describes a process for coating a substrate with at least two layers, characterized by the following steps: a) applying a first layer comprising a first inorganic component to a substrate or to one of at least one layer applied to a substrate; b) treating the first layer with a plasma; c) applying a second layer comprising a second inorganic component to the first layer treated with plasma in accordance with b).

### CROSS REFERENCE TO RELATED PATENT APPLICATION

The present patent application claims the right of priority under 35 U.S.C. §119 (a)-(d) of German Patent Application No.103 56 823.9, filed Dec. 5, 2003.

### BACKGROUND OF THE INVENTION

1. Field of the Invention

The invention relates to a process for coating a substrate with at least two layers each comprising at least one inorganic component.

2. Description of the Prior Art

In order to be able to use transparent plastics such as polycarbonate (PC) or polymethyl metacrylate (PMMA) externally, e.g. for the glazing of motor cars, it is necessary for them to be protected not only against photochemical exposure but also mechanical exposure. Damage caused by photochemical exposure can be prevented, for example, by the sheet of transparent plastic having a first coating which halts the UV fraction of daylight but is transparent to the visible fraction (UV protection coat). Damage caused by mechanical attack can be prevented, for example, with the aid of a second, scratch-resistant coating (scratch-resistant coat). The scratch-resistant layer is applied to the UV protection coat. Both requirements can be met in particular by means of organic sol-gel coatings, which are known in principle from the prior art.

A problem which occurs here is that the first layer, i.e. the lower, UV protection layer, and the second layer, i.e. the upper, scratch-resistant layer, do not adhere sufficiently well to one another, so that under mechanical and/or thermal stress the upper, scratch-resistant layer readily detaches from the underlying UV protection layer, meaning that scratch protection is no longer adequate.

It is an object of the present invention, therefore, to provide a process for coating a substrate with at least two layers, which results in sufficient adhesion to one another of two layers each comprising at least one inorganic component.

### SUMMARY OF THE INVENTION

The present invention is directed to a process for coating a substrate with at least two layers, that includes a) applying a first layer comprising a first inorganic component to a substrate or to one of at least one layer applied to a substrate, b) treating the first layer with a plasma, c) applying a second layer comprising a second inorganic component to the first layer treated with plasma in accordance with b).

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

The invention provides a process for coating a substrate with at least two layers, characterized by the following steps:
a) applying a first layer comprising a first inorganic component to a substrate or to one of at least one layer applied to a substrate
b) treating the first layer with a plasma
c) applying a second layer comprising a second inorganic component to the first layer treated with plasma in accordance with b).

The inventive plasma treatment of the first layer prior to application of the second layer produces sufficiently good adhesion, particularly also in the case of mechanical and/or thermal exposure.

A plasma for the purposes of the present invention is a partly ionized gas under atmospheric pressure or reduced pressure.

As substrate it is possible to use any desired materials, e.g. plastics, metals. Preference is given to using transparent materials, e.g. transparent plastics such as polycarbonate or PMMA.

The first layer is applied in accordance with step a) of the process of the invention to the substrate or to one of at least one layer applied to the substrate. This means that the first layer is applied either directly to the substrate or to one of possibly two or more layers applied to the substrate. This means that between the substrate and the first layer, comprising a first inorganic component, in accordance with the process of the invention it is possible to apply any desired additional layers. The first layer comprises at least one inorganic component. This layer is also referred to below for simplicity as first inorganic layer or first inorganic coating.

The first inorganic layer can be, for example, an organic coating, a sol-gel coating or a layer deposited by plasma chemistry that comprises at least one inorganic constituent.

The organic coating comprising-at least one inorganic constituent may be composed, for example, of an organic polymer in which inorganic particles are dispersed. The inorganic constituent or constituents may also, however, be attached to the organic polymer via covalent bonds, such as, for example, copolymers of acrylate-functional alkoxysilanes with typical olefinically unsaturated organic monomers. A further possibility of inorganic modification of organic coatings is the in situ polycondensation of low molecular mass sol-gel monomers such as tetraethyl orthosilicate, in which case the inorganic constituents then generally exhibit only weak interactions with the organic polymer.

The first inorganic layer is preferably a sol-gel coating. Inorganic sol-gel coatings which can be used for the purposes of the invention as first and/or second layer are known in principle. They are obtained by hydrolysis and condensation of low molecular mass silanes, normally in a solvent and in the presence of at least one catalyst. After the sol has been applied to the substrate that is to be coated, the sol is cured-to the gel by thermal treatment or irradiation.

Suitable low molecular mass silanes which can be used for producing sol-gel coatings are for example silanes of the formula (I):
(R¹)ₐ(R²)_{b}Si(OR³)_{c}
where
R¹, R² is hydrogen, an optionally substituted C₁-C₂₀ alkyl or C₆ aryl radical,
R³ is a C₁-C₈ alkyl radical or a phenyl radical,
a and b independently of one another are 0, 1, 2 or 3 and
c is 1, 2, 3 or 4, the sum a+b+c being 4.

Preference is given to using alkoxysilanes of the formula (II):
(R¹)ₐ(R²)_{b}Si(OR³)_{c}
where
R¹, R² is hydrogen, a C₁-C₈ alkyl or C₆ aryl radical,
R³ is a C₁-C₄ alkyl radical,
a and b independently of one another are 0, 1, 2 or 3 and
c is 1, 2, 3 or 4, the sum a+b+c being 4.

The following suitable alkoxysilanes and organoalkoxysilanes may be mentioned by way of example:
a) Si(OCH₃)₄, Si(OC₂H₅)₄
b) CH₃—Si(OCH₃)₃, C₂H₅—Si(OCH₃)₃, phenyl-Si(OCH₃)₃, CH₃—Si(OC₂H₅)₃, C₂H₅—Si(OC₂H₅)₃, phenyl-Si(OC₂H₅)₃, 3-glycidyloxypropyl-Si(OCH₃)₃, 3-acetoxypropyl-Si(OCH₃)₃, 3-methacryloyloxypropyl-Si(OCH₃)₃, 3-mercaptopropyl-Si(OCH₃)₃, 3-cyanopropyl-Si(OCH₃)₃, isocyanatopropyl-Si(OCH₃)₃, 3-aminopropyl-Si(OCH₃)₃
c) (CH₃)₂Si(OCH₃)₂, (CH₃)₂Si(OC₂H₅)₂, (C₂H₅)₂Si(OCH₃)₂, (C₂H₅)₂Si(OC₂H₅)₂, (n-butyl)₂Si(OC₂H₅)₂, (n-butyl)₂Si(OCH₃)₂, (i-propyl)₂Si(OC₂H₅)₂, (i-propyl)₂Si(OCH₃)₂, (CH₃)(phenyl)Si(OC₂H₅)₂, (CH₃)(phenyl)Si(OCH₃)₂, (CH₃)(H)Si(OCH₃)₂, (CH₃)(H)Si(OC₂H₅)₂, (CH₃)(vinyl)Si(OCH₃)₂, (CH₃)(vinyl)Si(OC₂H₅)₂, (CH₃)₂Si(O-phenyl)₂, (C₂H₅)₂Si(O-phenyl)₂
d) (CH₃)₃Si—OCH₃, (CH₃)₃Si—OC₂H₅, (C₂H₅)₃Si—OCH₃, (C₂H₅)₃Si—OC₂H₅, (CH₃)₃Si—Ophenyl, (C₂H₅)₃Si—Ophenyl, (phenyl)(CH₃)₂SiOCH₃, (phenyl)(CH₃)₂SiOC₂H₅, (phenyl)₂(CH₃)SiOCH₃, (phenyl)₂(CH₃)SiOC₂H₅, (phenyl)₃SiOCH₃, (phenyl)₃SiOC₂H₅, (i-propyl)(CH₃)₂SiOCH₃, (i-propyl)(CH₃)₂SiOC₂H₅, (i-propyl)₂(CH₃)SiOCH₃, (i-propyl)₂(CH₃)SiOC₂H₅, (i-propyl)₃SiOCH₃, (i-propyl)₃SiOC₂H₅, (n-butyl)(CH₃)₂SiOCH₃, (n-butyl)(CH₃)₂SiOC₂H₅, (n-butyl)₂(CH₃)SiOCH₃, (n-butyl)₂(CH₃)SiOC₂H₅, (n-butyl)₃SiOCH₃, (n-butyl)₃SiOC₂H₅.

Further examples of inorganic monomers are polyfunctional alkoxysilanes and silanols of the formula (III):
{[(R⁴O)_{d}R⁶_{3-d}Si]—(CH₂)ₖ}ᵢ—X—{(CH₂)₁—[SiR⁷₃₋ₑ(OR⁵)ₑ]}ⱼ
where
R⁴, R⁵ independently of one another is hydrogen, a C₁-C₈ alkyl and/or C₆ aryl radical,
R⁶, R⁷ independently of one another is an optionally substituted C₁-C₂₀ alkyl or C₆ aryl radical,
d and e independently of one another are 1, 2 or 3,
the sum i+j is greater than or equal to 2,
k and l independently of one another are an integer from 0 to 10 and
X represents a bridging structural unit to which a number of i+j silanol and/or alkoxysilyl groups [(R⁴O)_{d}R⁶_{3-d}Si] and/or. [SiR⁷₃₋ₑ(OR⁵)ₑ]ⱼ are attached via a chemical bond.

Besides the low molecular mass silanes of which a number have been exemplified above it is possible in addition to use alkoxides of the elements B, Al, Ti, Zr, Sn or In, for example, for producing the inorganic sol-gel coatings. By this means it is possible for example to enhance the mechanical resistance of the coating for use as a scratch-resistant layer.

Besides the low molecular mass silanes and/or alkoxides of the specified elements it is additionally possible to add particulate oxides, oxide hydrates and/or -hydroxides of the elements Si, B, Al, Ti, Zr, Sn or In. By way of example mention may be made of nanoparticulate SiO₂, which is usually used in the form of an aqueous or solvent-containing dispersion. In order to obtain a transparent layer structure, inorganic particles of corresponding fineness are used. The average particle size of the inorganic particles, determined by means of ultracentrifugation, amounts to not more than 200 nm, preferably from 1- to 100 nm, more preferably from 5 to 50 nm and very preferably from 5 to 20 nm.

Suitable solvents that can be used to produce the inorganic sol-gel coatings are for example ketones, alcohols, esters and ethers, with alcohols being preferred. Examples of suitable alcohols that may be mentioned include methanol, ethanol, 1-propanol, 2-propanol, 1-butanol, 2-butanol, 1-pentanol and 1-methoxy-2-propanol, 1,2-ethanodiol and n-butyl glycol.

Suitable acidic and basic catalysts that can be used to hydrolyse the low molecular mass silanes are in particular Brønsted acids and Brønsted bases, preference being given to Brønsted acids. It is preferred to use strong acids in a concentration of from 0.05 to 1.0 mol/litre (water), with not only inorganic acids, such as hydrochloric acid or sulphuric acid, but also organic acids, such as p-toluenesulphonic acid, being suitable.

Any adjustment of the pH that may be necessary is achieved by adding a suitable amount of a preferably weak acid or base. The resulting pH should then be from 4 to 8, which considerably enhances the stability of the UV protection formulations on storage.

The first inorganic layer serves preferably as UV protection layer, especially when the substrate is a polycarbonate plastic. In that case the layer comprises at least one organic and/or inorganic UV absorber, as a result of which the first inorganic layer in the wavelength range from 300 to 400 nm has at least one absorption band with an extinction of at least 0.2, preferably 0.5.

On account of their migration tendency and their photochemical stability it is preferred to employ inorganic UV absorption agents. Examples of such inorganic UV absorption agents are oxides, hydroxides or oxide hydrates of the elements Si, Sn, Ti, B, In, Al, B, and Ce. Preference is given to using titanium dioxide, zinc oxide and/or cerium dioxide.

Where the entire layer structure comprising at least one first and one second, overlying layer is to be transparent, it is necessary to use inorganic particles of corresponding fineness which serve, for example, as UV absorption agents. The average particle size of the inorganic particles, determined by means of ultracentrifugation, is in this case not more than 200 nm, preferably from 1 to 100 nm, more preferably from 5 to 50 nm and very preferably from 5 to 20 nm. The amount of the inorganic particles present in the first layer is preferably in the range from 5 to 50% by weight, more preferably from 15 to 35% by weight.

In addition to a UV absorber it is also possible, furthermore, for commonly used HALS compounds (hindered amine light stabilizer) to be present in the first layer.

The second layer, comprising a second inorganic component (and also referred to below as second inorganic layer or second inorganic coating), which is applied to the first layer in accordance with step c) of the process of the invention, may be the same or a different inorganic layer, i.e. it may comprise the same or one or more other inorganic components.

The second inorganic layer may be, in turn, for example, an organic coating, a sol-gel coating or a layer deposited by plasma chemistry and comprising at least one inorganic constituent.

The organic coating comprising at least one inorganic constituent may be composed, for example, of an organic polymer in which inorganic particles are dispersed. The inorganic constituent or constituents may also, however, be attached to the organic polymer by way of covalent bonds, such as copolymers of arcylate-functional alkoxysilanes with typical olefinically unsaturated organic monomers. A further possibility of the inorganic modification of organic coatings is the in situ polycondensation of low molecular mass sol-gel monomers such as tetraethyl orthosilicate, in which case the inorganic constituents then usually exhibit only weak interactions with the organic polymer.

Preferably the second inorganic layer is a sol-gel coating or a layer deposited by plasma chemistry.

With particular preference the second inorganic layer is a sol-gel coating, which in principle may be constructed from the same constituents as specified above for the first inorganic layer.

Atop the second layer it is possible in accordance with the process of the invention to apply any desired further layers.

The second layer, which in accordance with step c) following the plasma treatment of step b) is applied to the first layer, serves preferably for improving the mechanical stability (scratch resistance) of the layer structure as a whole. A layer is regarded as a scratch-resistant layer for the purposes of the invention if after a given scratch resistance or abrasion test (e.g. Taber Abraser, Sand Trickle or Reciprocating Shear Test) it exhibits better scratch resistance than a conventionally coated substrate. The layer is subjected to mechanical stress through the Taber Abraser Test in accordance with standard ASTM D 1044, for example. In that test friction wheels which have been provided with abrasive particles run over the area under investigation for a prescribed number of cycles (generally 1000). Subsequently the increase in the scattered light at the exposed sites is measured in accordance with ASTM D 1003. A surface having a scattered-light increase of less than 5% is generally considered to be particularly scratch-resistant.

Since both organic and inorganic UV absorbers frequently reduce the scratch-resistance of sol-gel coatings it may also be appropriate for the second coating to contain less UV absorber than the underlying layer, i.e. the first, inorganic layer. In this specific case the extinction of any absorption band in the range from 300 to 400 nm is therefore preferably less than 0.2, more preferably less than 0.1.

The inorganic sol-gel coatings can be applied by commonplace techniques to corresponding substrates and can be cured subsequently under appropriate conditions. Application can take place, for example, by dipping, flooding, spraying, knife coating, pouring or brushing. Any solvent present is then evaporated and the coating is cured at room temperature or elevated temperature and/or using suitable radiation (in the case of radiation-curing coatings, for example).

A further possibility for applying the second layer in accordance with step c) is offered by the deposition of this layer by means of a plasma, in which case as process gases use is made, for example, of organosilicon monomers such as tetramethylsilane, tetramethyldisiloxane, hexamethyldisiloxane, octa-methylcyclotetrasiloxane, tetramethoxysilane or other silanes and oxygen-containing gases. These layers are also referred to below as plasma layers. In this case use is made, for example, of the low-pressure plasma technique described later on below. Finally the second layer, preferably a scratch-resistant layer, can also be applied by means of vapour deposition or sputtering in a high vacuum.

In principle two different types of plasma are known for the plasma treatment of surfaces or substrates:
1. The low-pressure or low-temperature plasma at pressures less than 1013 mbar, preferably from 10⁻³ to 10 mbar. The term “low-temperature plasma” derives from the fact that at these low pressures, on electrical excitation, the energy of the electrical field is transferred to the electrons, while the ions remain at room temperature.
2. The atmospheric-pressure plasma at atmospheric pressure of essentially 1013 mbar.

The plasma used for the process of the invention in accordance with step b) comprises at least hydrogen or a hydrogen-containing compound and/or oxygen or a oxygen-containing compound. Examples of suitable compounds are: H₂, O₂, H₂, CO₂, CO, CH₄, N₂O, NH₃, H₂O₂. Preference is given to using H₂O.

Suitable techniques for producing a plasma are those by means of electrical discharge at a pressure reduced as compared with the atmospheric pressure of 1013 mbar, using direct voltage or high-frequency or microwave excitation. These techniques are known in the art under the designation low-pressure or low-temperature plasma. The plasma in this case has a pressure of less than 1013 mbar, preferably from 10⁻³ to 10 mbar.

In the case of the low-pressure plasma technique the workpiece to be treated is in a container which can be evacuated by means for example of pumps. Within this container there is at least one electrode, if the plasma is excited by electrical excitation by means of direct voltage or by means of high-frequency fields. The excitation frequency used may be, for example: 13.56 MHz, 27.12 MHz, 2.45 GHz. Where excitation is by means of microwave radiation, there is a region at one point on the wall of the container that is transparent to microwave radiation and through which the microwave radiation is coupled into the container. A suitable process gas is admitted to the evacuated process chamber until a pressure of less than 1013 mbar is reached, preferably from 10⁻³ to 10 mbar. Subsequently the plasma is ignited by means of an electrical field and is maintained for a desired period of time. Through a suitable selection of excitational frequency, process gas, electrical power, process pressure and process duration it is possible to achieve a multiplicity of desired effects. The duration of the plasma treatment in accordance with step b) is preferably from 0.5 to 10 minutes, more preferably from 1 to 2 minutes.

Since gas molecules are highly mobile and the electrical discharge which produces the plasma fills the whole container almost uniformly, a plasma is also extremely suitable for the uniform treatment of workpieces of complex shape, with bores, undercuts or the like. It is likewise possible to treat flat shaped articles on both sides in one process step, if a suitable mount is used. The plasma, i.e. the highly reactive process gas made of excited molecules and/or atoms, ions and electrons, and the radiation likewise produced influences only the topmost monolayers of the workpiece to be treated, without attacking the structure of the material.

Another plasma likewise suitable for carrying out the process of the invention is the atmospheric-pressure plasma. A feature of the atmospheric-pressure plasma technique is that there is no need for a complex pump system to maintain a reduced pressure during the process. However, a pump system, albeit a less complicated one, is needed to remove the ambient air from the reactor, if operating with a gas other than the ambient air. In contradistinction to the low-pressure plasma technique, the plasma is produced by means of a multiplicity of narrowly localized microdischarges of short duration, with diameters in the submillimetre range and a duration of a few nanoseconds. These microdischarges are generated by applying a high voltage of from 10 to 20 kV with a medium frequency of 20 to 60 kHz against a counterelectrode. In the microdischarges the actual plasma is formed, which also forms the highly reactive species. Since these microdischarges extend only over a region which is narrowly delimited in space, the predominant part of the gas is not ionized and therefore remains at ambient temperature.

### EXAMPLES

### Preparation of an Alkoxysilane-Modified Polyurethane Adhesion Promoter

A) Preparation of the polyol component: 9.24 g of Desmophen® 800 and 3.08 g of Desmophen® 670 were dissolved with stirring in 3.08 g of n-butyl acetate, and then 0.4 g of a 10% strength by weight solution of zinc(II) octoate in diacetone alcohol, 0.2 g of a 10% strength by weight solution of Baysilone® OL 17 in diacetone alcohol and also 170.5 g of diacetone alcohol were added. This gave 186.5 g of the clear, colourless and storage-stable polyol component.

B) Preparation of the polyisocyanate component: 462.4 g of Desmodur® Z 4470 (70% by weight in n-butyl acetate) were diluted with 27.23 g of n-butyl acetate, and then over the course of about 2 h, 60.4 g of N-″butylaminopropyltrimethoxysilane were added dropwise at a rate such that the reaction temperature (internal thermometer) did not rise above 40° C. After cooling, 550 g of the clear, pale yellow and storage-stable polyisocyanate component were obtained.

C) Preparation of the ready-to-process adhesion promoter: 42.3 g of component A) and 7.7 g of component B) were mixed with stirring. The clear solution obtained was used within one hour.

The Desmophen® 800, Desmophen® 670 and Desmodur® Z 4470 components used as described above are commercial products of Bayer AG, Leverkusen. Baysilone® OL 17 is a levelling additive from GE Bayer Silicones, Leverkusen.

The adhesion promoter was applied by spin coating (2000 rpm, 20 s holding time), and then was subjected to thermal treatment at 130° C. for 60 minutes. The layer thickness achieved in this way was typically about 0.3-0.6 μm.

### Preparation of a UV Protection Formulation

The polyfunctional organosilane used was oligomeric cyclo-{OSi[(CH₂)₂Si(OC₂H₅)₂(CH₃)]}₄. It was prepared as described in US-A 6 136 939, Example 2.

Nano-CeO₂ was used in the form of a commercially available (Aldrich), 20% by weight dispersion, stabilized with 2.5% by weight of acetic acid.

First of all the concentration of the commercially available nano-CeO₂ dispersion was raised from 20% by weight to 30% by weight by condensing off water on a rotary evaporator.

Then, with stirring, 64.1 g of oligomeric cyclo-{OSi[(CH₂)₂Si(OC₂H₅)₂—(CH₃)]}₄ and 76.4 g of tetraethyl orthosilicate were dissolved in 66.4 g of 1-methoxy-2-propanol and 66.4 g of isopropanol. After 5 minutes the mixture was then hydrolysed with stirring with 10.7 g of 0.1 N p-toluenesulphonic acid solution, and after 30 minutes of stirring with a further 10.7 g. After a further 60 minutes of stirring, finally, 91.8 g of the nano-CeO₂ dispersion concentrated as described above (30% by weight) were added, and then the mixture was stirred for 60 minutes and finally left to stand at room temperature for 48 hours. Finally, the mixture was diluted to a solids content of 20% by weight by addition of 1-methoxy-2-propanol. This gave a clear, yellow mixture containing (calculated) 30.0% by weight of nano-CeO₂ in the solids.

The UV protection formulation was applied by spin coating within an hour after curing of the adhesion promoter. The UV protection coating material as well was thermally treated at 103° C. for 60 minutes.

### Scratch-Resistant Coating Material 1

Scratch-resistant coating material 1 was prepared using a sol-gel condensate available commercially from General Electric (coating material AS 4700), which is composed essentially of a reaction product of methyltrimethoxysilane with aqueous silica sol (dispersion of SiO₂ nanoparticles in water).

### Scratch-Resistant Coating Material 2

Scratch-resistant coating material 2 was prepared by applying a sol-gel condensate produced as follows: with stirring, 16.4 g of oligomeric cyclo-{OSi[(CH₂)₂Si(OC₂H₅)₂(CH₃)]}₄ and 30.2 g of tetraethyl orthosilicate were dissolved in 86.3 g of 1-methoxy-2-propanol. After 5 minutes the mixture was then hydrolysed, with stirring, with 4.3 g of 0.1 N p-toluenesulphonic acid solution, and after 30 minutes of stirring with a further 4.3 g. After another 60 minutes of stirring, 11.2 g of an 82.5% strength solution of aluminium tri(sec-)butoxide complexed with ethyl acetoacetate (molar ratio 1:1) in 1-methoxy-2-propanol were then added. After 15 minutes of stirring 13.5 g of 2.5% strength acetic acid were added and the reaction mixture was stirred for 60 minutes more. This gave a colourless, water-thin sol-gel condensate.

### Example 1

A sheet of bisphenol A polycarbonate from. Bayer AG, trade name Makrolon®, with a size of 10×10 cm, which had been coated with the above-described adhesion promoter and with the above-described inorganic UV protection coating material in a thickness of approximately 3 μ, was mounted on a rotatable substrate holder which was located within an evacuable vessel. Below this rotating plate at a distance of 50 mm was mounted a cathode of type PK 75 from Leybold, which could be connected alternatively to a direct voltage supply or to an RF generator operating at a frequency of 27.12 MHz. Also located on the vessel was an inlet for the process gases, a port which can be closed with a valve, and which was connected to a vacuum pump apparatus, and a valve for venting the vessel.

The vessel was first evacuated to a pressure of 5·10⁻⁴. The substrate holder was then rotated at 20 rpm and steam was admitted to a pressure of 10⁻¹ mbar. Then the high-frequency generator was switched on and a steam plasma was produced with an electrical power of 300 W. The sample is treated with this plasma for 2 minutes. Then the high-frequency generator was switched off, the gas supply was closed, the vessel was vented and the sample was removed.

Following this plasma treatment of the first layer, a layer 5 μ thick of the coating material AS 4700 from General Electric (scratch-resistant coating material 1) was applied as a second layer by flooding. Following application, the wet coating film was baked at 130° C. for 60 minutes.

In the case of this sample and the following samples, the adhesion of the layer was assessed by means of a cross-cut test according to ISO 2409, using the Scotch® adhesive tape 610 from 3M. The adhesion was assessed initially immediately after the last coating layer had been applied. Thereafter the sample was boiled in distilled water for thermal exposure. After 30 minutes the sample was removed and, after cooling, the adhesion test described above was repeated. This test was repeated until a total boiling time of 3 hours had been reached.

The results of the adhesion test are given in Table 1. The adhesion is assessed in accordance with ISO 2409 with values between 0=no detachment and 5=complete detachment of the layer. It can be seen that in Example 1 the layer does not detach even after 3 hours of thermal exposure in boiling water, and hence it possesses outstanding adhesion.

### Example 2

The substrate coated in analogy to Example 1 with an adhesive promoter and UV protection layer is treated with a plasma in the same way as in Example 1. In contradistinction to Example 1, however, the plasma treatment lasted 5 minutes. Additionally the plasma is generated not with RF excitation but instead by means of direct voltage with a power of 440 W. Likewise in analogy to Example 1, a second layer was applied to this sample in the form of a layer 5 μ thick of the coating material AS 4700 from General Electric (scratch-resistant coating material 1). The result of the adhesion test is shown in Table 1.

### Comparative Example

The sample was produced as in Example 1 but without plasma treatment of the UV protection coating material prior to the application of the second layer (scratch-resistant coating material 1).

The testing of the adhesion of the second layer to the first layer took place again with a cross-cut test according to ISO 2409. The results of the adhesion test are shown in Table 1.

TABLE 1
Results of the cross-cut test according to ISO 2409

| Boiling | | | Comparative |
|---|---|---|---|
| time [min] | Example 1 | Example 2 | example |
| 0 | 0 | 0 | 5 |
| 30 | 0 | 0 | 5 |
| 60 | 0 | 0 | — |
| 90 | 0 | 0 | — |
| 120 | 0 | 0 | — |
| 150 | 0 | 1 | — |
| 180 | 1 | 1 | — |

### Example 3

In analogy to Example 1 the above-described adhesion promoter and also the UV protection coating material were applied to and cured on a polycarbonate sheet. After the plasma treatment likewise described in Example 1, the above-described scratch-resistant coating material 2 was then applied by flooding and cured at 125° C. for 60 minutes. In a first test the scratch-resistant coating material 2 was applied 2 days after the end of the plasma treatment, and in a second test 5 days after the end of the plasma treatment (storage in each case under ambient conditions without special measures). After the scratch-resistant coating material 2 had been cured, the coated polycarbonate sheets were investigated for adhesion. (by the cross-cut test; see Example 1), and they were then stored in boiling water (for a total of 2 h), carrying out testing of the adhesion as described in Example 1 every 30 minutes. The result is summarized in Table 2 below.

TABLE 2
Results of the cross-cut test according to ISO 2409

| | Storage 2 days | Storage 5 days |
|---|---|---|
| Boiling time [min] | (Test 1) | (Test 2) |
| 0 | 0 | 0 |
| 30 | 0 | 0 |
| 60 | 0 | 0 |
| 90 | 0 | 0 |
| 120 | 0 | 0 |

The plasma treatment of the invention is accordingly effective for at least 5 days under ambient conditions.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for coating a substrate with at least two layers, comprising the following steps:
a) applying a first layer comprising a first inorganic component to a substrate or to one of at least one layer applied to a substrate
b) treating the first layer with a plasma
c) applying a second layer comprising a second inorganic component to the first layer treated with plasma in accordance with b).

2. The process according to claim 1, wherein the first and/or second inorganic component is a hydrolysis product and/or condensation product of a low molecular mass alkoxysilane and/or silanol.

3. The process according to claim 1, wherein the first and/or second layer is a sol-gel coating.

4. The process according to claim 2, wherein the first and/or second layer comprises in addition to at least one hydrolysis product and/or condensation product of a low molecular mass alkoxysilane and/or silanol at least one alkoxide of the elements B, Al, Ti, Zr, Sn or In.

5. The process according to claim 1, wherein the plasma comprises at least hydrogen or a hydrogen-containing compound or oxygen or an oxygen-containing compound.

6. The process according to claim 5, wherein the plasma comprises water.

7. The process according to claim 1, wherein the first layer comprises at least one UV absorption agent.

8. The process according to claim 2, wherein the first and/or second layer is a sol-gel coating.

9. The process according to claim 3, wherein the first and/or second layer comprises in addition to at least one hydrolysis product and/or condensation product of a low molecular mass alkoxysilane and/or silanol at least one alkoxide of the elements B, Al, Ti, Zr, Sn or In.

10. The process according to claim 2, wherein the plasma comprises at least hydrogen or a hydrogen-containing compound or oxygen or an oxygen-containing compound.

11. The process according to claim 10, wherein the plasma comprises water.

12. The process according to claim 3, wherein the plasma comprises at least hydrogen or a hydrogen-containing compound or oxygen or an oxygen-containing compound.

13. The process according to claim 12, wherein the plasma comprises water.

14. The process according to claim 4, wherein the plasma comprises at least hydrogen or a hydrogen-containing compound or oxygen or an oxygen-containing compound.

15. The process according to claim 14, wherein the plasma comprises water.

16. The process according to claim 2, wherein the first layer comprises at least one UV absorption agent.

17. The process according to claim 3, wherein the first layer comprises at least one UV absorption agent.

18. The process according to claim 4, wherein the first layer comprises at least one UV absorption agent.

19. The process according to claim 5, wherein the first layer comprises at least one UV absorption agent.

20. The process according to claim 6, wherein the first layer comprises at least one UV absorption agent.
